(19) United States
(12) Patent Application Publication
(10) Pub. No.: US 2007/0275216 A1
(43) Pub. Date: Nov. 29, 2007

(54) SANDWICH COMPONENT, IN PARTICULAR TRANSPARENT COMPONENT FOR A VEHICLE ROOF SYSTEM

(76) Inventors: Rainer Grimm, Frankfurt (DE); Joachim Roeder, Muehlheim (DE); Horst Boehm, Frankfurt/Main (DE)

Correspondence Address: CARLSON, GASKEY & OLDS, P.C., 400 WEST MAPLE ROAD, SUITE 350, BIRMINGHAM, MI, 48009, US

(21) Appl. No.: 11/751,122

(22) Filed: May 21, 2007

(30) Foreign Application Priority Data
May 26, 2006 (EP) 06 010 948.5

(51) Int. Cl. B32B 17/06

(52) U.S. Cl. 428/192; 428/426

(57) ABSTRACT

A sandwich component, in particular a transparent component for a vehicle roof system, includes first and second panes that are connected with each other by an adhesive layer. At least one carrier part is embedded in the adhesive layer.

### RELATED APPLICATIONS

The application claims priority to European Application No. 06 010 948.5, which was filed on 26 May 2006.

### BACKGROUND OF THE INVENTION

The present invention relates to a sandwich component, in particular a transparent component for a vehicle roof system. The sandwich component includes first and second panes that are connected with each other by an adhesive layer. A sandwich component of this type is disclosed in DE 10 2004 030 086.

One requirement of such a sandwich component is that in the event of damage it is ensured that any splinters are prevented from penetrating into an interior of the vehicle. This is ensured in that the first and second panes are connected with each other by the adhesive layer. In this way, an inherently stable structure is provided from which no splinters can detach themselves even when damaged.

When this type of sandwich component is used for a cover of a sliding roof system of a motor vehicle, for instance, a further demand is made. The sandwich component is required to offer a high strength while having a low weight. To this end, in most cases a stiffening frame is provided that is connected to the cover. The stiffening frame then serves to connect the cover to a mechanism of the sliding roof system.

The object of the present invention is to provide an improved sandwich component which, firstly, ensures that in the event of damage no splinters can enter the interior of the vehicle and, secondly, exhibits a high strength combined with low weight.

### SUMMARY OF THE INVENTION

To achieve this object, in a sandwich component of the type initially mentioned, provision is made according to the invention for at least one carrier part to be embedded in an adhesive layer that connects first and second panes to each other. The invention is based on a finding that a stiffening frame may be dispensed with if carrier parts, which are required for mounting the sandwich component, are glued in or foamed in directly between the first and second panes. This has no adverse effects on the splinter protection. In addition, the necessary strength of the sandwich component may be ensured by a suitable shaping.

The first and second panes may be made of glass. For the adhesive layer, an expandable material is particularly suitable, for instance a polyurethane (PU) foam.

The carrier part may be used for mounting the sandwich component to the vehicle or to a sliding roof system. The carrier part may also serve to mount other components to the sandwich component, such as, e.g., a seal.

Advantageous further developments of the invention are apparent from the dependent claims.

These and other features of the present invention can be best understood from the following specification and drawings, the following of which is a brief description.

### BRIEF DESCRIPTION OF THE DRAWINGS

FIG. 1 shows a schematic top view of a vehicle roof with two sandwich components;

FIG. 2 shows a schematic section taken along the plane II-II of FIG. 1;

FIG. 3 shows a schematic section taken through a further embodiment;

FIG. 4 shows a further embodiment in section; and

FIG. 5 shows yet another embodiment in section.

### DETAILED DESCRIPTION OF THE PREFERRED EMBODIMENT

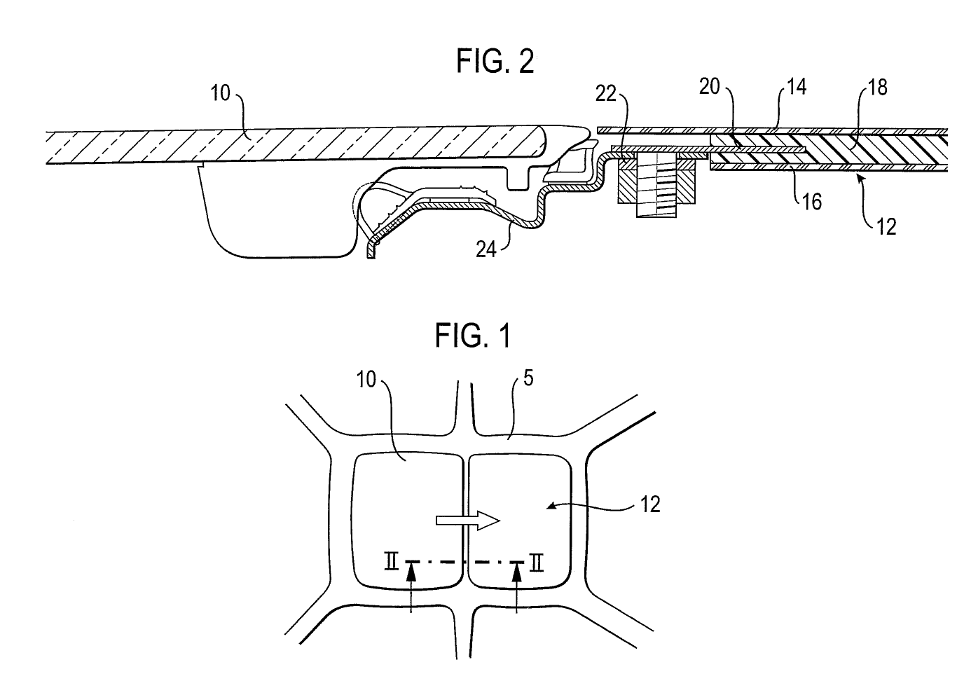

FIG. 1 schematically shows a vehicle roof 5 in a top view, which is shown in this example as a panoramic roof. The panoramic roof consists of a cover 10 that is adapted to be slid rearwardly, and a firmly mounted pane element 12. Both the cover 10 and the pane element 12 are transparent.

As can be seen in FIG. 2, the pane element 12 is composed of a first pane 14 and a second pane 16, which are both made of glass. Both float glass and tempered glass may be used. As an alternative, panes made of a plastic material may be employed.

An adhesive layer 18 made of an expandable material is provided between the first and second panes 14, 16. The expandable material is PU foam. Foamed into an edge region of the adhesive layer 18 is a carrier part 20 that serves to attach the pane element 12 to a holding bar 22, and also allows a seal carrier 24 provided with a water gutter to be fitted.

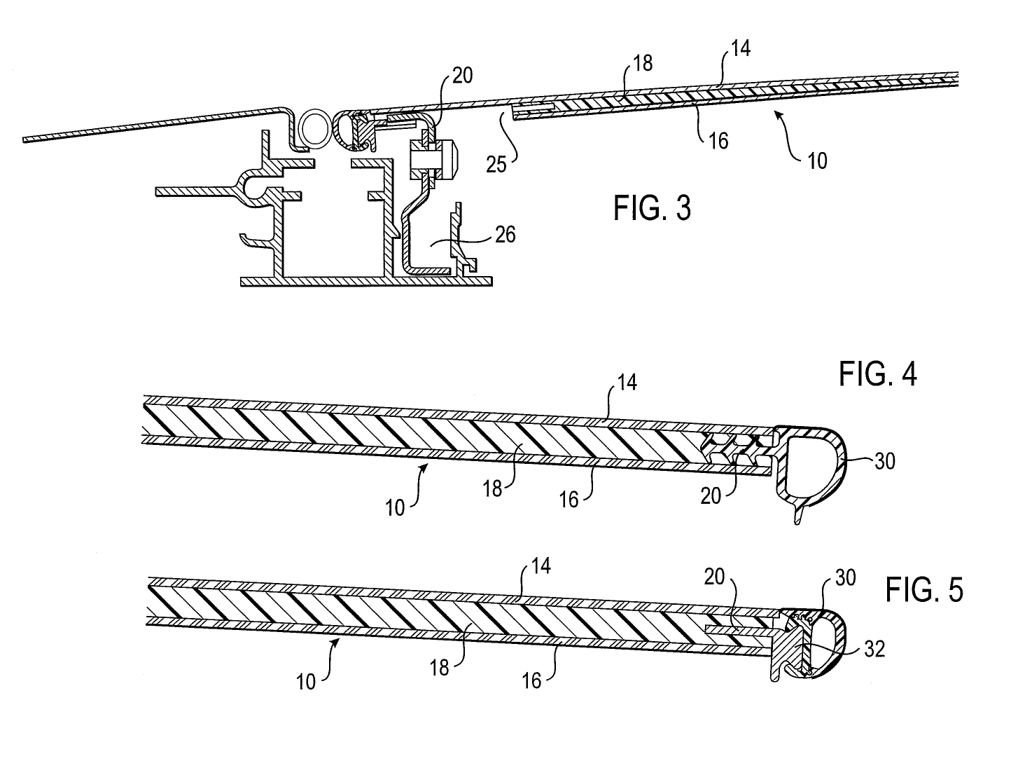

FIG. 3 shows a further embodiment. Unlike in the embodiment shown in FIG. 2, the sandwich component of FIG. 3 is a cover 10 that has two panes 14, 16 and an adhesive layer 18 of an expandable material. Also in this example, a carrier part 20 is foamed in the adhesive layer 18. In the region of the carrier part 20, a recess 25 is provided in the lower pane 16 and in the adhesive layer 18. The carrier part 20 extends as far as on both sides of the recess 25. A tongue is bent out downward in the center, which serves to connect the cover 10 with a schematically indicated sliding roof system 26.

FIG. 4 shows, in section, an edge portion of a cover 10. Here, the carrier part 20 is an anchoring extension that is formed in one piece with a seal 30 and is foamed into the adhesive layer 18 made of the PU foam.

Similar to FIG. 4, FIG. 5 shows an edge portion of a cover 10. In this case, the carrier part 20 is made in one piece with a seal carrier 32 and is again foamed into the adhesive layer 18.

A feature that all of the embodiments have in common is that the carrier part 20 is firmly connected with the sandwich component at minimum expense. It is not required to bolt the carrier part to, for instance, a reinforcement frame later. Instead, the carrier part 20 is directly foamed in between the first and second panes 14, 16 during the manufacture of the sandwich component.

The necessary stiffness of the sandwich component can be attained by suitably shaping the first and second panes 14, 16 and, hence, the adhesive layer 18 made of the PU foam.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A sandwich component for a vehicle roof system, comprising:
first and second panes that are connected with each other by an adhesive layer; and at least one carrier part embedded in the adhesive layer.

2. The sandwich component according to claim 1, wherein the first and second panes are made of glass.

3. The sandwich component according to claim 1, wherein the adhesive layer comprises an expandable material.

4. The sandwich component according to claim 3, wherein the adhesive layer comprises a PU foam.

5. The sandwich component according to claim 1, wherein the adhesive layer is transparent.

6. The sandwich component according to claim 1, wherein the at least one carrier part is a cover holder.

7. The sandwich component according to claim 1, wherein the at least one carrier part is a seal carrier.

8. The sandwich component according to claim 1, wherein the first and second panes are curved to increase stiffness of the sandwich component.
